(19) United States
(12) Patent Application Publication
(10) Pub. No.: US 2018/0189562 A1
(43) Pub. Date: Jul. 5, 2018

(54) CHARACTER RECOGNITION APPARATUS, CHARACTER RECOGNITION METHOD, AND COMPUTER PROGRAM PRODUCT

(71) Applicants: Kabushiki Kaisha Toshiba, Minato-ku (JP); Toshiba Digital Solutions Corporation, Kawasaki-shi (JP)

(72) Inventors: Atsuhiro YOSHIDA, Fuchu (JP); Yoshiaki KUROSAWA, Zama (JP)

(73) Assignees: Kabushiki Kaisha Toshiba, Minato-ku (JP); Toshiba Digital Solutions Corporation, Kawasaki-shi (JP)

(21) Appl. No.: 15/906,264

(22) Filed: Feb. 27, 2018

Related U.S. Application Data
(63) Continuation of application No. PCT/JP2016/075721, filed on Sep. 1, 2016.

(30) Foreign Application Priority Data
Sep. 4, 2015 (JP) 2015-174414

(51) Int. Cl. G06K 9/00; G06K 9/34

(52) U.S. Cl. CPC G06K 9/00456; G06K 2209/01; G06K 9/344

(57) ABSTRACT

According to an embodiment, a character recognition apparatus includes a character string image acquisition unit, a combination graph generation unit, a combination graph integration unit and an output unit. The character string image acquisition unit acquires a character string image. The combination graph generation unit performs a character recognition process on the character string image and generates a combination graph. The combination graph integration unit integrates a plurality of combination graphs generated from a plurality of character string images including an identical character string or integrates a plurality of combination graphs generated by performing a plurality of different character recognition processes on the single character string image. The output unit outputs the integrated combination graph or a recognition character string obtained based on the integrated combination graph.

### CROSS-REFERENCE TO RELATED APPLICATIONS

This application is a continuation of PCT international application Ser. No. PCT/JP2016/075721 filed on Sep. 1, 2016, which designates the United States and the People's Republic of China, incorporated herein by reference, and which claims the benefit of priority from Japanese Patent Application No. 2015-174414, filed on Sep. 4, 2015, the entire contents of which are incorporated herein by reference.

### FIELD

Embodiments described herein relate generally to a character recognition apparatus, a character recognition method, and a program.

### BACKGROUND

Various efforts have been made to improve recognition accuracy in a character recognition field typified by an optical character recognition/reader (OCR). For example, there has been known a technique of performing a character recognition process on each of a plurality of character string images including the same character string and selecting a recognition result with a high degree of reliability for corresponding characters to obtain a final recognition character string.

However, there is a case where the correct recognition character string is not obtained according to the conventional method of selecting the recognition result with the high degree of reliability because, for example, the recognition result with the high degree of reliability is not necessarily correct and there is also a case where delimitation of characters in a character string image is not correct, which requires further improvement.

### BRIEF DESCRIPTION OF THE DRAWINGS

FIG. 1 is a block diagram illustrating a hardware configuration example of a character recognition apparatus;

FIG. 2 is a block diagram illustrating a functional configuration example of the character recognition apparatus;

FIG. 3 is a view illustrating an example of a combination graph;

FIG. 4 is a view for describing an example of a data structure of the combination graph;

FIGS. 5A and 5B are views illustrating an example of a cumulative combination graph and a new combination graph;

FIG. 6 is a view illustrating a new cumulative combination graph obtained by integrating the new combination graph illustrated in FIG. 5 into the cumulative combination graph;

FIG. 7 is a flowchart illustrating an example of a processing procedure performed by the character recognition apparatus;

FIG. 8 is a flowchart for describing an overview of an integration process in Step S105 of FIG. 7;

FIG. 9 is a flowchart illustrating a processing procedure of Step S205 in FIG. 8;

FIG. 10 is a view illustrating some pieces of character candidate information extracted from the cumulative combination graph and the new combination graph illustrated in FIG. 5; and

FIG. 11 is a view illustrating a state where the combination graph is separated into a single connection path.

### DETAILED DESCRIPTION

According to an embodiment, a character recognition apparatus includes a character string image acquisition unit, a combination graph generation unit, a combination graph integration unit and an output unit. The character string image acquisition unit acquires a character string image. The combination graph generation unit performs a character recognition process on the character string image and generates a combination graph. The combination graph integration unit integrates a plurality of combination graphs generated from a plurality of character string images including an identical character string or integrates a plurality of combination graphs generated by performing a plurality of different character recognition processes on the single character string image. The output unit outputs the integrated combination graph or a recognition character string obtained based on the integrated combination graph.

Hereinafter, a character recognition apparatus, a character recognition method, and a computer program product according to embodiments will be described in detail with reference to the drawings.

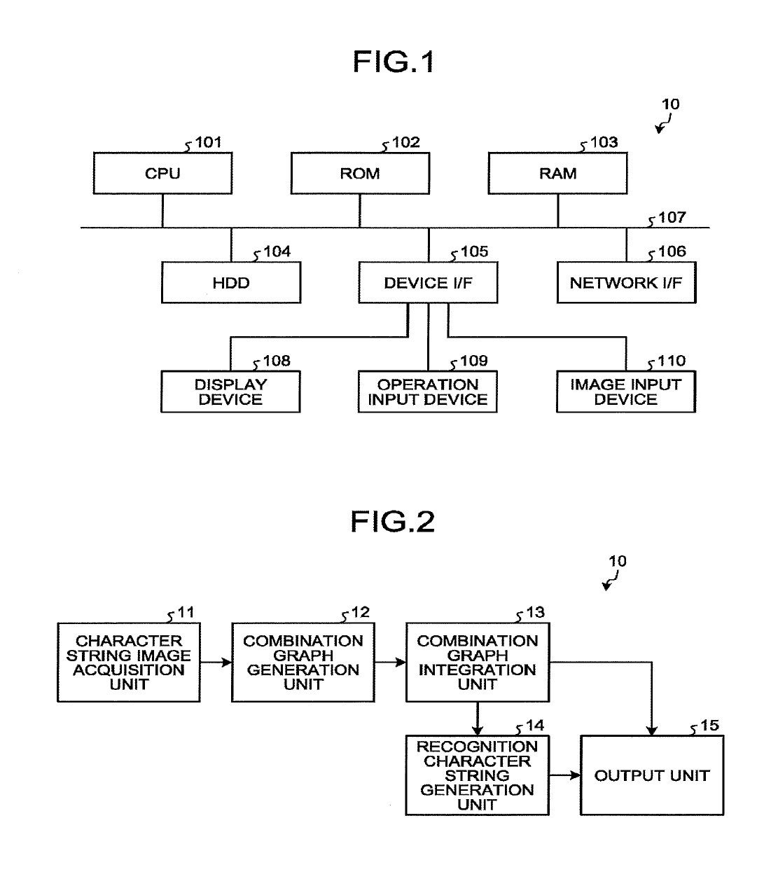

FIG. 1 is a block diagram illustrating a hardware configuration example of a character recognition apparatus 10 according to an embodiment. The character recognition apparatus 10 can adopt, for example, a hardware configuration as a general computer. In this case, the character recognition apparatus 10 includes a central processing unit (CPU) 101, a read only memory (ROM) 102, a random access memory (RAM) 103, a hard disk drive (HDD) 104, a device I/F 105, a network I/F 106, a bus 107 for connection of these parts, and the like as illustrated in FIG. 1. Then, the character recognition apparatus 10 can implement various functions relating to character recognition, for example, as the CPU 101 executes a program stored in the ROM 102, the HDD 104, or the like using the RAM 103 as a work area.

The device I/F 105 is an interface configured to connect peripheral devices such as a display device 108 such as a liquid crystal display, an operation input device 109 such as a keyboard and a mouse, and an image input device 110 such as a camera and a scanner to the character recognition apparatus 10. The network I/F 106 is a communication interface configured to connect the character recognition apparatus 10 to a network such as the Internet and a local area network (LAN).

FIG. 2 is a block diagram illustrating a functional configuration example of the character recognition apparatus 10 according to the embodiment. For example, the character recognition apparatus 10 includes a character string image acquisition unit 11, a combination graph generation unit 12, a combination graph integration unit 13, a recognition character string generation unit 14, and an output unit 15, as illustrated in FIG. 2, as functional constituent elements implemented by cooperation of the above-described hardware and software (program).

The character string image acquisition unit 11 acquires a character string image to be subjected to a character recognition process. For example, the character string image acquisition unit 11 may be configured to acquire a character string image input from the image input device 110 such as a camera and a scanner via the device I/F 105 or may be configured to acquire a character string image transmitted from an external device connected to the network via the network I/F 106. In addition, the character string image acquisition unit 11 may be configured to store a character string image acquired in advance in the HDD 104 or the like, and read out the character string image from the HDD 104 or the like at the time of executing the character recognition process.

The character string image acquisition unit 11 performs pre-processing necessary to perform the character recognition process, such as binarization processing, on the acquired character string image, and passes the pre-processed character string image to the combination graph generation unit 12. Incidentally, an existing technique can be directly used for the pre-processing necessary to perform the character recognition process, and thus, the detailed description thereof will be omitted.

The combination graph generation unit 12 performs the character recognition process on the character string image received from the character string image acquisition unit 11, and generates a combination graph which is a graph that puts results of the character recognition process together with respect to this character string image. The character recognition process is a process of, for example, extracting all character areas each of which is regarded as one character from the character string image, obtaining a characteristic amount from each character area, and acquiring one or more candidate characters for each character area and a recognition score indicating a likelihood thereof based on the characteristic amount. In addition, delimitation of the character area with respect to the character string image and character recognition for the character area may be performed at the same time in the character recognition process. The combination graph generation unit 12 performs the character recognition process on the character string image received from the character string image acquisition unit 11 and puts positions and sizes of the individual character areas in a character string image IS, candidate characters and recognition scores acquired from the individual character areas, respectively, and the like together to generate a combination graph. Incidentally, an existing technique can be directly utilized, for example, for a method of extracting the character area or a method of calculating the characteristic amount used in the character recognition as a specific technique of the character recognition process on the character string image IS, the detailed description thereof will be omitted.

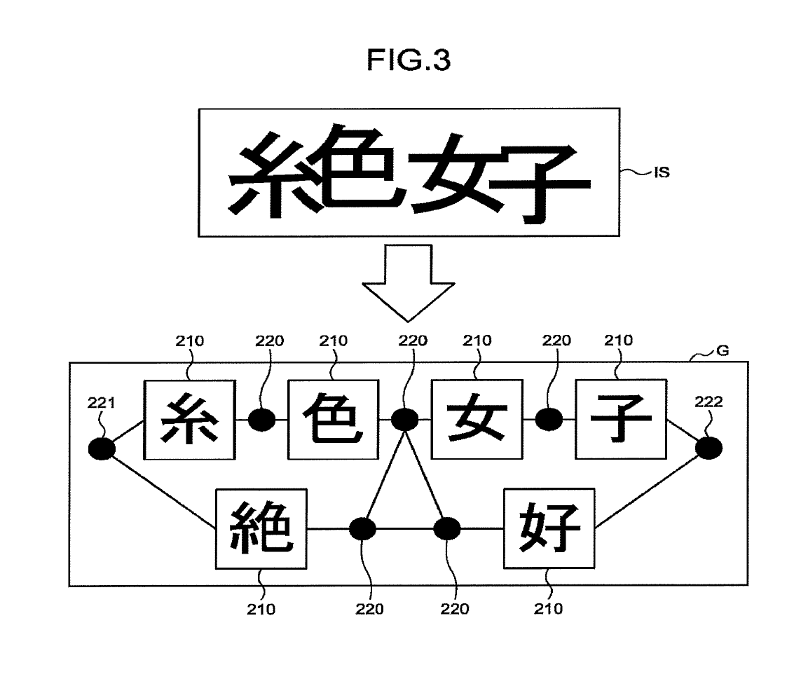

FIG. 3 is a view illustrating an example of a combination graph G generated by the combination graph generation unit 12. As illustrated in FIG. 3, the combination graph G is a graph in which pieces of character candidate information 210 each of which indicates a recognition result for each character area regarded as one character in the character string image IS are connected in the arrangement order of the respective character areas in the character string image IS. The combination graph G may include a plurality of connection paths corresponding to a plurality of patterns with different delimitation of the character areas in the character string image IS. The connection path indicates connection of the pieces of the character candidate information 210 in the character string image IS. In the example of FIG. 3, different connection paths are set between a case where “ [symbol] ” and “ [symbol] ” are regarded as two characters and a case where “ [symbol] ” and “ [symbol] ” are regarded as one character of “ [symbol] ”. In addition, different connection paths are set between a case where “ [symbol] ” and “ [symbol] ” are regarded as two characters and a case where “ [symbol] ” and “ [symbol] ” are regarded as one character of “ [symbol] ”. Thus, the combination graph G illustrated in FIG. 3 includes four kinds of connection paths, that is, the connection path connecting “ [symbol] ”→“ [symbol] ”→“ [symbol] ”→“ [symbol] ”, the connection path connecting “ [symbol] ”→“ [symbol] ”→“ [symbol] ”, the connection path connecting “ [symbol] ”→“ [symbol] ”→“ [symbol] ”, and the connection path connecting “ [symbol] ”→“ [symbol] ”. Incidentally, when the delimitation of the character areas in the character string image IS is uniquely specified, there is one connection path included in the combination graph G.

In a combination graph G, a connection relationship between pieces of adjacent character candidate information 210 is represented by connection information 220. The connection referred to herein means that two characters corresponding, respectively, to the two pieces of character candidate information 210 are adjacent to each other. When the combination graph G is graphically represented as illustrated in FIG. 3, the connection information 220 is arranged between the two pieces of adjacent character candidate information 210. Incidentally, a start position 221 is arranged at a head of a character string, and an end position 222 is arranged at an end of the character string as the special connection information 220.

FIG. 3 is an example of graphical representation of the combination graph G generated when the character string image IS including a horizontal character string in which characters are arranged in the horizontal direction is set as a target of a character recognition process. Each of the pieces of character candidate information 210 arranged in the horizontal direction represents a recognition result for each character area which is regarded as one character in the character string image IS. Incidentally, a character of each of the pieces of character candidate information 210 illustrated in FIG. 3 indicates a candidate character with a highest recognition score among candidate characters acquired by character recognition for the corresponding character area. Hereinafter, a description will be given regarding a case where the character string image IS including such a horizontal character string is set as a target of a character recognition process. However, the basic configuration of the combination graph G is the same even in a case where the character string image IS including a vertical character string in which characters are arranged in the vertical direction is set as a target of a character recognition process, except that only the arrangement of the character candidate information 210 changes from the horizontal direction to the vertical direction.

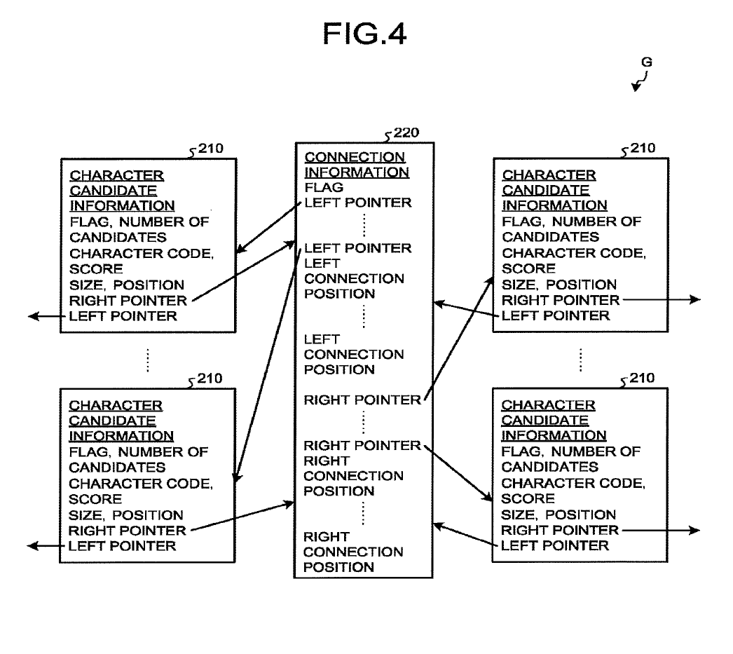

Here, a specific example of a data structure of the combination graph G will be described. FIG. 4 is a view for describing the example of the data structure of the combination graph G. FIG. 4 schematically illustrates one piece of connection information 220 and a plurality of pieces of character candidate information 210 relating to the relevant connection information 220 partially extracted from the combination graph G.

As described above, the character candidate information 210 is information obtained by character recognition on the character area regarded as one character, and for example, includes a flag, the number of candidates, a character code, a score, a size, a position, a right pointer, a left pointer, and the like. The flag represents an attribute or the like of the character candidate information 210. The number of candidates represents the number of character candidates included in the character candidate information 210. The character code is a character code of each of one or more candidate characters included in the character candidate information 210. The score is a recognition score corresponding to each candidate character. The size is a size of a character area (a circumscribed rectangle of a character) corresponding to the character candidate information 210. The position is position information representing a position (a left end position or a right end position of the character area in this embodiment) in the character string image IS of the character area corresponding to the character candidate information 210. The right pointer is a pointer pointing to the connection information 220 corresponding to the right end position of the character candidate information 210. The left pointer is a pointer pointing to the connection information 220 corresponding to the left end position of the character candidate information 210. Incidentally, it may be sufficient if the pointer can specify an area on a memory in which target information is stored, and it is possible to use, for example, an address or an index on the memory.

The connection information 220 is information for connection of pieces of the adjacent character candidate information 210 and includes a flag, a plurality of left pointers, a plurality of left connection positions, a plurality of right pointers, and a plurality of right connection positions. The flag represents an attribute or the like of the connection information 220. The left pointer is a pointer pointing to the character candidate information 210 on a left side between the pieces of adjacent character candidate information 210 with the connection information 220 interposed therebetween. The left connection position is information for understanding the position of the character candidate information 210 indicated by the left pointer, and, for example, the right end position which is the position information of the character candidate information 210 is registered as the left connection position. The right pointer is a pointer pointing to the character candidate information 210 on a right side between the pieces of adjacent character candidate information 210 with the connection information 220 interposed therebetween. The right connection position is information for understanding the position of the character candidate information 210 indicated by the right pointer, and, for example, the left end position which is the position information of the character candidate information 210 is registered as the right connection position.

The combination graph G sometimes includes a plurality of connection paths as described above, there are a plurality of connection relationships between the pieces of character candidate information 210. Thus, the plurality of left pointers and left connection positions, and the plurality of right pointers and right connection positions are provided in the connection information 220. Each of the pointers can be switched between valid and invalid, and whether each pointer is valid or invalid is described in, for example, the flag.

As in the example illustrated in FIG. 3, the connection relationship between the pieces of adjacent character candidate information 210 can also be represented by two pieces of the connection information 220. In this case, one of right pointers in the connection information 220 on the left side between the two pieces of connection information 220 points to the connection information 220 on the right side, and the same position as the right connection position of the connection information 220 on the right side is registered in the right connection position corresponding to this right pointer. In addition, one of left pointers in the connection information 220 on the right side between the two pieces of connection information 220 points to the connection information 220 on the left side, and the same position as the left connection position of the connection information 220 on the left side is registered in the left connection position corresponding to this left pointer.

The start position 221 illustrated in FIG. 3 is the special connection information 220 in which only a right pointer and a right connection position are registered, and the end position 222 illustrated in FIG. 3 is the special connection information 220 in which only a left pointer and a left connection position are registered. Such an attribute of the connection information 220 is described in the above-described flag. Incidentally, one start position 221 and one end position 222 are generally provided in one combination graph G, but a plurality of start positions 221 and end positions 222 may be present in the combination graph G.

Although the combination graph G having the configuration in which the connection relationship between pieces of adjacent character candidate information 210 is represented by the connection information 220 has been exemplified in the present embodiment, the embodiment is not limited thereto. For example, the combination graph G may be configured not to include the connection information 220 by setting the character candidate information 210 to directly point to another piece of adjacent character candidate information 210. In this case, a plurality of left pointers or a plurality of right pointers pointing to the other adjacent character candidate information 210 may be set in the character candidate information 210 instead of a left pointer or a right pointer pointing to one piece of connection information 220.

Whenever receiving the character string image IS from the character string image acquisition unit 11, the combination graph generation unit 12 generates the combination graph G as described above and passes the generated combination graph G to the combination graph integration unit 13. In particular, the combination graph generation unit 12 generates a plurality of the combination graphs G for one character string and passes the generated combination graphs G to the combination graph integration unit 13 in the present embodiment. For example, the combination graph generation unit 12 generates a plurality of combination graphs G by performing a character recognition process on the plurality of character string images IS including the same character string, and passes the plurality of combination graphs G to the combination graph integration unit 13. In addition, the combination graph generation unit 12 may generate a plurality of combination graphs G by performing a plurality of different character recognition processes on the single character string image IS and pass the plurality of combination graphs G to the combination graph integration unit 13. Incidentally, the plurality of character string images IS including the same character string can be configured to be identifiable by, for example, a file name of an image file or the like.

The combination graph integration unit 13 integrates the plurality of combination graphs G generated by the combination graph generation unit 12 for one character string, that is, the plurality of combination graphs G generated from the plurality of character string images IS including the same character string, or integrates the plurality of combination graphs G generated by performing the plurality of different character recognition processes on the single character string image IS. In the present embodiment, a method of sequentially integrating the combination graphs G one by one is adopted. Hereinafter, a combination graph G integrated until a certain time is referred to as a cumulative combination graph G_acc (a first combination graph), and a combination graph G to be newly integrated is referred to as a new combination graph G_new (a second combination graph).

When receiving the first combination graph G among the plurality of combination graphs G generated by the combination graph generation unit 12 for one character string, the combination graph integration unit 13 saves this graph as an initial cumulative combination graph G_acc. Then, when receiving the second combination graph G, the combination graph integration unit 13 sets this as the new combination graph G_new, integrates the new combination graph G_new into the cumulative combination graph G_acc, and saves the integrated combination graph G as a new cumulative combination graph G_acc. The combination graph integration unit 13 repeats the same process for the third and subsequent combination graphs G, and passes a finally obtained cumulative combination graph G_acc to the recognition character string generation unit 14 or the output unit 15 when the integration of all the combination graphs G generated by the combination graph generation unit 12 for the one character string is ended.

The integration of the new combination graph G_new into the cumulative combination graph G_acc is performed as follows. That is, the combination graph integration unit 13 specifies a corresponding relationship between each piece of character candidate information 210 included in the cumulative combination graph G_acc and each piece of character candidate information 210 included in the new combination graph G_new, performs merging (joining into one) of corresponding pieces of the character candidate information 210 with each other, and adds character candidate information 210 on the new combination graph G_new side that does not correspond to any of the character candidate information 210 on the cumulative combination graph G_acc side to the cumulative combination graph G_acc, thereby integrating the new combination graph G_new into the cumulative combination graph G_acc.

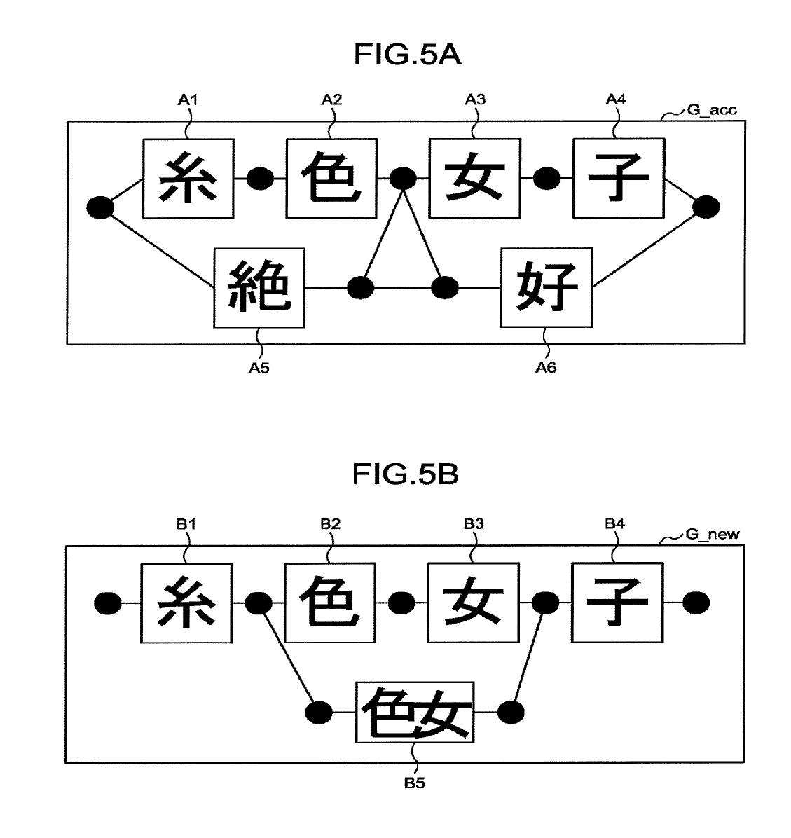

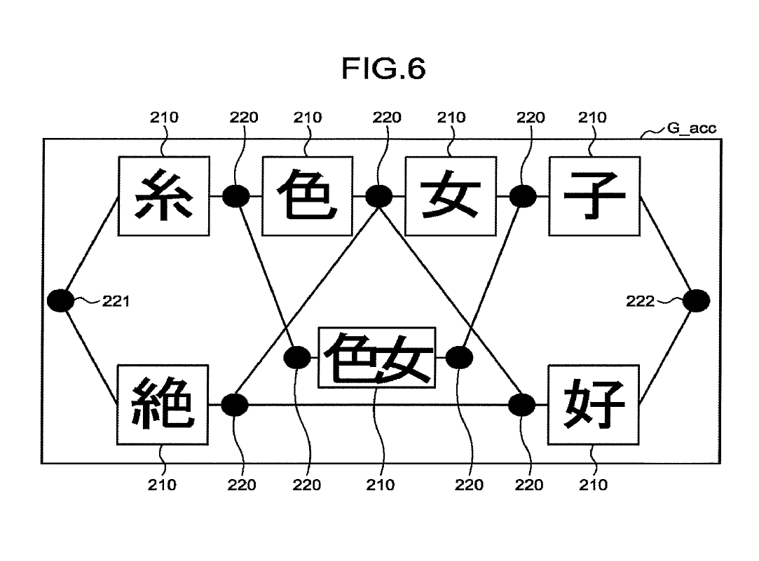

Hereinafter, a specific example of such an integration process will be described with reference to FIGS. 5A, 5B and 6. FIG. 5A illustrates an example of the cumulative combination graph G_acc, and FIG. 5B illustrates an example of the new combination graph G_new. FIG. 6 illustrates a new cumulative combination graph G_acc obtained by integrating the new combination graph G_new of FIG. 5B into the cumulative combination graph G_acc of FIG. 5A. In FIGS. 5A and 5B, reference signs A1, A2, A3, A4, A5, and A6 are attached to the character candidate information 210 on the cumulative combination graph G_acc side, and reference signs B1, B2, B3, B4, and B5 are attached to the character candidate information 210 on the new combination graph G_new side in order to distinguish each piece of character candidate information 210 included in the cumulative combination graph G_acc and the new combination graph G_new.

In the present embodiment, the corresponding relationship between each piece of character candidate information 210 included in the cumulative combination graph G_acc and each piece of character candidate information 210 included in the new combination graph G_new is specified using position information (a left end position or a right end position of a character area in the character string image IS) included in the character candidate information 210 as a clue.

The combination graph integration unit 13 retrieves a pair of connection information 220 having the right connection position substantially coincident with the left end position of the character area registered as the position information and connection information 220 having the left connection position substantially coincident with the right end position of the character area registered as the position information, from the cumulative combination graph G_acc, for each of the pieces of character candidate information 210 included in the new combination graph G_new. The expression, “substantially coincident” means that a difference between two positions falls within a predetermined error range. Accordingly, two pieces of connection information 220 on the cumulative combination graph G_acc side corresponding to connection information 220 on the right and left sides of the character candidate information 210 on the new combination graph G_new side are specified.

Next, the combination graph integration unit 13 determines whether one piece of character candidate information 210 sandwiched between the two pieces of connection information 220 on the specified cumulative combination graph G_acc side is present in the cumulative combination graph G_acc, and determines that this character candidate information 210 corresponds to the character candidate information 210 on the new combination graph G_new side when the character candidate information 210 is present in the cumulative combination graph G_acc. At this time, it is desirable for the combination graph integration unit 13 to determine whether the character candidate information 210 on the cumulative combination graph G_acc side and the character candidate information 210 on the new combination graph G_new side correspond to each other in consideration of a degree of coincidence between character candidates included in both pieces of character candidate information 210 and the like. For example, when both pieces of character candidate information 210 include a predetermined number of same character candidates or more, it is determined that the both pieces of character candidate information 210 correspond to each other.

The combination graph integration unit 13 performs merging (joining into one) of the character candidate information 210 on the new combination graph G_new side into the character candidate information 210 on the corresponding cumulative combination graph G_acc side, with respect to character candidate information 210 for which the corresponding character candidate information 210 is found in the cumulative combination graph G_acc among the pieces of character candidate information 210 included in the new combination graph G_new. Specifically, character codes and recognition scores of candidate characters obtained by character recognition are merged. Character codes of the candidate characters are sorted in order of recognition scores when merging the character candidate information 210. When the recognition scores are different for the same character code, a character code with a higher recognition score is adopted. In addition, when the number of candidate characters exceeds a predetermined upper limit value due to the merging, a character code with a low recognition score is not registered.

In the example illustrated in FIGS. 5A and 5B, B1, B2, B3, and B4 on the new combination graph G_new side correspond to A1, A2, A3, and A4 on the cumulative combination graph G_acc side, respectively, and thus, B1 is merged into A1, B2 is merged into A2, B3 is merged into A3, and B4 is merged into A4.

In addition, with respect to character candidate information 210 for which the corresponding character candidate information 210 is not found in the cumulative combination graph G_acc among the pieces of character candidate information 210 included in the new combination graph G_new, the combination graph integration unit 13 adds this character candidate information 210 on the new combination graph G_new side as new character candidate information 210 on the cumulative combination graph G_acc side. Specifically, the combination graph integration unit 13 changes the right pointer of the character candidate information 210 that needs to be added to point to the connection information 220 on the cumulative combination graph G_acc side corresponding to the connection information 220 on the right side of the relevant character candidate information 210, and changes the left pointer of the character candidate information 210 that needs to be added to point to the connection information 220 on the cumulative combination graph G_acc side corresponding to the connection information 220 on the left side of the relevant character candidate information 210. In addition, the combination graph integration unit 13 additionally registers the left pointer pointing to the character candidate information 210 and the left connection position to the connection information 220 on the cumulative combination graph G_acc side corresponding to the connection information 220 on the right side of the character candidate information 210 that needs to be added, and additionally registers the right pointer pointing to the character candidate information 210 and the right connection position to the connection information 220 on the cumulative combination graph G_acc side corresponding to the connection information 220 on the left side of the character candidate information 210 that needs to be added. As a result, the character candidate information 210 on the new combination graph G_new side which does not correspond to any of the character candidate information 210 on the cumulative combination graph G_acc side is added to the cumulative combination graph G_acc.

In the example illustrated in FIGS. 5A and 5B, there are two pieces of character candidate information 210 of A2 and A3 between connection positions on the cumulative combination graph G_acc side of B5 on the new combination graph G_new side, and any one piece of character candidate information 210 on the cumulative combination graph G_acc side corresponding to B5 on the new combination graph G_new side is not found. Thus, B5 on the new combination graph G_new side is added as new character candidate information 210 between A1 and A4 on the cumulative combination graph G_acc side.

The combination graph integration unit 13 sequentially performs the integration process as described above in order of connection from the left side, for the entire character candidate information 210 in the new combination graph G_new. In addition, there is a case where a plurality of pairs of pieces of connection information 220 on the cumulative combination graph G_acc side corresponding to the right and left sides of the character candidate information 210 on the new combination graph G_new side is found. In this case, the above-described merging or addition of the character candidate information 210 is performed for each pair. With this integration, the new cumulative combination graph G_acc illustrated in FIG. 6 is generated from the cumulative combination graph G_acc and the new combination graph G_new illustrated in FIG. 5.

Next, exceptional processing will be described. When any one piece of connection information 220 on the cumulative combination graph G_acc side corresponding to the right and left sides of the character candidate information 210 of the new combination graph G_new is not found, there is a high possibility that the character candidate information 210 is erroneously read, and thus, the merging or addition to the cumulative combination graph G_acc is not performed.

In addition, when the connection information 220 on the cumulative combination graph G_acc side corresponding to the left side of the character candidate information 210 of the new combination graph G_new is found, and the connection information 220 corresponding to the right side thereof is not found, this character candidate information 210 is added to the cumulative combination graph G_acc, and the connection information 220 on the right side of the relevant character candidate information 210 is added to the cumulative combination graph G_acc as a new end position 222. At this time, when the connection information 220 to be added as the new end position 222 includes a right pointer and a right connection position, these right pointer and right connection position are deleted. In addition, when the connection information 220 to be added as the new end position 222 includes a left pointer pointing to the character candidate information 210 other than the character candidate information 210 to be added and a left connection position, the left pointer and left connection position are also deleted.

In addition, when the connection information 220 on the cumulative combination graph G_acc side corresponding to the right side of the character candidate information 210 of the new combination graph G_new is found, and the connection information 220 corresponding to the left side thereof is not found, this character candidate information 210 is added to the cumulative combination graph G_acc, and the connection information 220 on the left side of the relevant character candidate information 210 is added to the cumulative combination graph G_acc as a new start position 221. At this time, when the connection information 220 to be added as the new start position 221 includes a left pointer and a left connection position, these left pointer and left connection position are deleted. In addition, when the connection information 220 to be added as the new start position 221 includes a right pointer pointing to the character candidate information 210 other than the character candidate information 210 to be added and a right connection position, the right pointer and right connection position are also deleted.

In addition, when the connection information 220 on the cumulative combination graph G_acc side corresponding to the right side of the character candidate information 210 of the new combination graph G_new is the start position 221, this character candidate information 210 is added to the cumulative combination graph G_acc as the character candidate information 210 to be connected to the left side of the start position 221, and a left pointer pointing to the relevant character candidate information 210 and a left connection position are added to the start position 221 on the cumulative combination graph G_acc side. Then, the start position 221 is changed to normal connection information 220 by rewriting an attribute of a flag. In addition, the connection information 220 on the left side of the relevant character candidate information 210 is added to the cumulative combination graph G_acc as a new start position 221. At this time, when the connection information 220 to be added as the new start position 221 includes a left pointer and a left connection position, these left pointer and left connection position are deleted. In addition, when the connection information 220 to be added as the new start position 221 includes a right pointer pointing to the character candidate information 210 other than the character candidate information 210 to be added and a right connection position, the right pointer and right connection position are also deleted.

In addition, when the connection information 220 on the cumulative combination graph G_acc side corresponding to the left side of the character candidate information 210 of the new combination graph G_new is the end position 222, this character candidate information 210 is added to the cumulative combination graph G_acc as the character candidate information 210 to be connected to the right of the end position 222, and a right pointer pointing to the relevant character candidate information 210 and a right connection position are added to the end position 222 on the cumulative combination graph G_acc side. Then, the end position 222 is changed to normal connection information 220 by rewriting an attribute of a flag. In addition, the connection information 220 on the right side of the relevant character candidate information 210 is added to the cumulative combination graph G_acc as a new end position 222. At this time, when the connection information 220 to be added as the new end position 222 includes a right pointer and a right connection position, these right pointer and right connection position are deleted. In addition, when the connection information 220 to be added as the new end position 222 includes a left pointer pointing to the character candidate information 210 other than the character candidate information 210 to be added and a left connection position, the left pointer and left connection position are also deleted.

The cumulative combination graph G_acc may be configured to have a plurality of start positions 221 and a plurality of end positions 222. When it is necessary to narrow down each of these start positions 221 and end positions 222 to one position, the narrowing-down is performed as follows. That is, all the right pointers of the start positions 221 except for the leftmost one among the plurality of start positions 221 are invalidated. Similarly, all the left pointers of the end positions 222 except for the rightmost one among the plurality of end positions 222 are invalidated. When pointers corresponding to the connection information 220 pointed by a right pointer and a left pointer of character candidate information 210 are invalid, the right pointer and left pointer of the character candidate information 210 are also invalidated. This process is repeated until there is no pointer to be invalidated. Finally, the connection information 220 and the character candidate information 210 in which all the pointers are invalid are deleted.

Although the integration process of the combination graph G having the configuration in which the connection relationship between the pieces of adjacent character candidate information 210 is indicated by the connection information 220 has been described as above, the same integration process can be applied even in a configuration in which character candidate information 210 directly points to another piece of adjacent character candidate information 210, that is, a case of using the combination graph G having a configuration in which the character candidate information 210 also has the function of the connection information 220. In this case, the connection information 220 on the right and left sides of the character candidate information 210 may be replaced with connection information in the character candidate information 210 in the above description.

The combination graph integration unit 13 repeats the above-described integration process for all the combination graphs G that needs to be integrated, and passes the integrated combination graph G to the recognition character string generation unit 14 or the output unit 15 when the integration of all the combination graphs G is ended.

The recognition character string generation unit 14 receives the integrated combination graph G from the combination graph integration unit 13, and executes predetermined processing such as knowledge processing with respect to this integrated combination graph G, thereby generating a recognition character string as a final character recognition result. Then, the recognition character string generation unit 14 passes the generated recognition character string to the output unit 15. Incidentally, an existing technique can be directly used for the processing such as the knowledge processing to generate the recognition character string, which is the final character recognition result, and thus, the detailed description thereof will be omitted.

The output unit 15 outputs the recognition character string generated by the recognition character string generation unit 14. In addition, the output unit 15 may be configured to output the combination graph G integrated by the combination graph integration unit 13, instead of or in addition to the recognition character string generated by the recognition character string generation unit 14. In the case of the configuration in which the output unit 15 outputs only the combination graph G, the character recognition apparatus 10 according to the embodiment can be configured not to include the above-described recognition character string generation unit 14.

A mode of outputting the recognition character string or the integrated combination graph G by the output unit 15 may be a mode in which the recognition character string or the integrated combination graph G is displayed on the display device 108, or may be a mode in which the recognition character string or the integrated combination graph G is transmitted to the external device connected to the network via the network I/F 106.

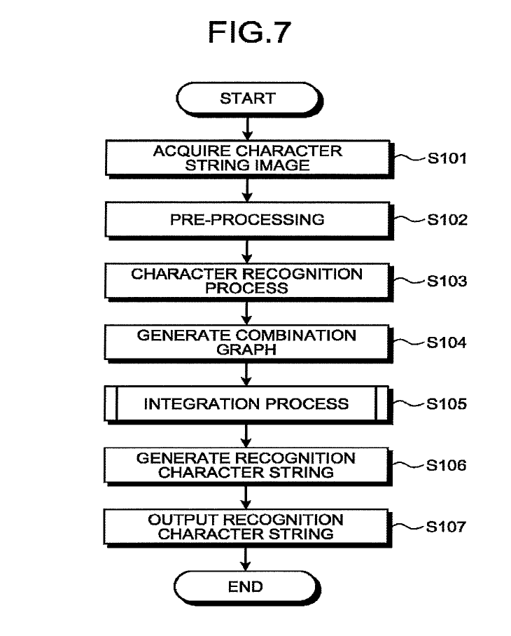

Next, an operation of the character recognition apparatus 10 according to the embodiment will be described. FIG. 7 is a flowchart illustrating an example of a processing procedure performed by the character recognition apparatus 10. For example, the character recognition apparatus 10 operates in accordance with a series of processing procedures illustrated in the flowchart of FIG. 7.

When the character recognition apparatus 10 starts to operate, first, the character string image acquisition unit 11 acquires a character string image IS as a target of the character recognition process (Step S101), performs pre-processing on the acquired character string image IS (Step S102), and passes the pre-processed character string image IS to the combination graph generation unit 12.

Next, the combination graph generation unit 12 executes the character recognition process on the character string image IS received from the character string image acquisition unit 11 (Step S103), and generates a combination graph G corresponding to a character string (Step S104). In the present embodiment, the combination graph generation unit 12 generates a plurality of combination graphs G corresponding to one character string by performing the character recognition process on each of a plurality of character string images IS including the same character string or performing a plurality of different character recognition processes on one character string image IS. The plurality of combination graphs G generated by the combination graph generation unit 12 is sequentially passed to the combination graph integration unit 13.

Next, the combination graph integration unit 13 executes the integration process of the plurality of combination graphs G received from the combination graph generation unit 12, that is, the plurality of combination graphs G corresponding to one character string (Step S105), and passes the integrated combination graph G to the recognition character string generation unit 14. Incidentally, the combination graph integration unit 13 passes the integrated combination graph G to the output unit 15 when the output unit 15 is configured to output the integrated combination graph G as described above.

Next, the recognition character string generation unit 14 generates a recognition character string which is a final character recognition result based on the integrated combination graph G received from the combination graph integration unit 13 (Step S106), and passes the recognition character string to the output unit 15. Incidentally, this processing in Step S106 is omitted when the output unit 15 is configured to output only the integrated combination graph G.

Finally, the output unit 15 outputs the recognition character string received from the recognition character string generation unit 14 (Step S107). Incidentally, the output unit 15 may output the integrated combination graph G received from the combination graph generation unit 12 instead of the recognition character string or together with the recognition character string.

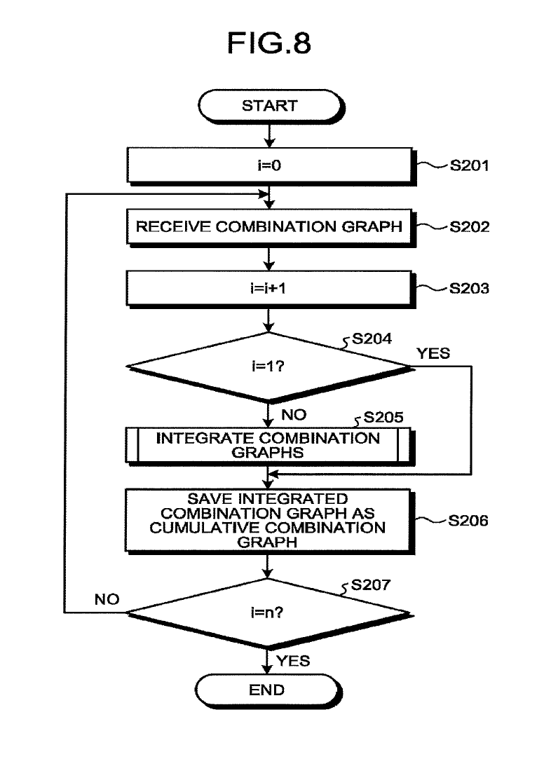

FIG. 8 is a flowchart for describing an overview of the integration process in Step S105 of FIG. 7, and illustrates a procedure of the integration process of sequentially integrating the new combination graph G_new into the cumulative combination graph G_acc. In FIG. 8, i represents a counter value, and n represents the number of the combination graphs G that needs to be integrated.

When the integration process is started, the combination graph integration unit 13 first initializes the counter value i (i=0) (Step S201). Thereafter, when the combination graph G is generated by the combination graph generation unit 12, the combination graph integration unit 13 receives the combination graph G from the combination graph generation unit 12 (Step S202), and increments the counter value i (i=i+1) (Step S203).

Next, the combination graph integration unit 13 confirms whether the counter value i is 1 and determines whether the combination graph G received in Step S202 is the first combination graph G among the plurality of combination graphs G that needs to be integrated (Step S204).

Here, when the combination graph G received in Step S202 is the first combination graph G (Step S204: Yes), the combination graph integration unit 13 saves the combination graph G directly as the cumulative combination graph G_acc (Step S206). On the other hand, when the combination graph G received in Step S202 is not the first combination graph G (Step S204: No), the combination graph integration unit 13 integrates this combination graph G, as a new combination graph G_new, into the stored cumulative combination graph G_acc (Step S205). Then, the integrated combination graph G is saved as a new cumulative combination graph G_acc (Step S206).

Thereafter, the combination graph integration unit 13 determines whether the counter value i has reached n to determine whether all the combination graphs G that need to be integrated have been integrated (Step S207). Then, when there is a combination graph G that has not been integrated (Step S207: No), the process returns to Step S202 to repeat the subsequent processing. When all the combination graphs G have been integrated (Step S207: Yes), the saved cumulative combination graph G_acc is passed to the recognition character string generation unit 14 or the output unit 15, thereby ending the series of processes.

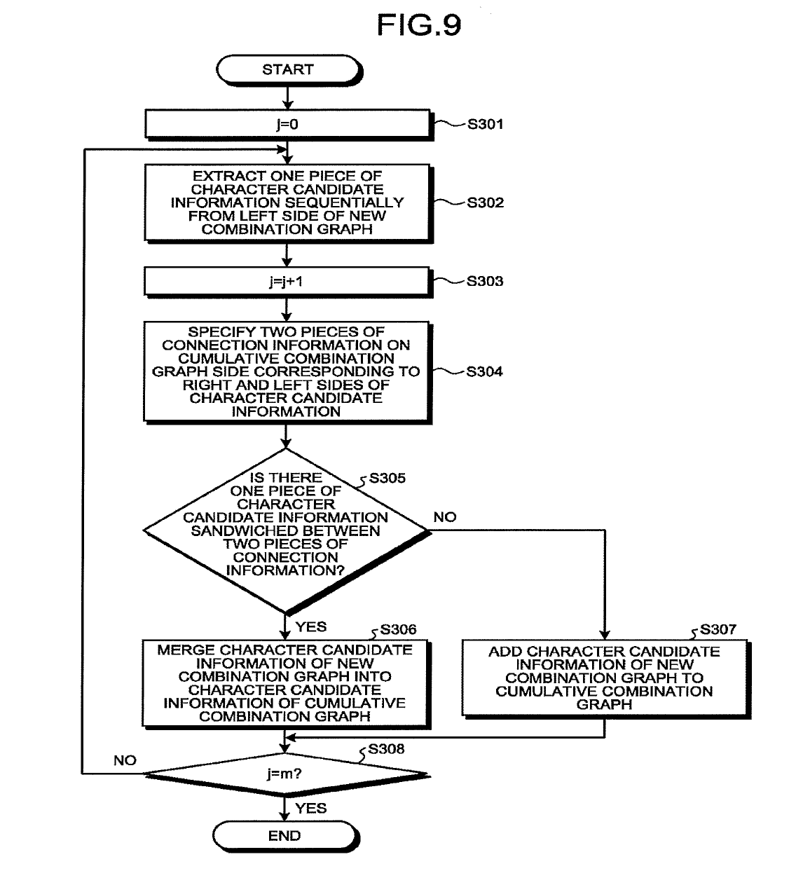

FIG. 9 is a flowchart illustrating a processing procedure of Step S205 in FIG. 8. In FIG. 9, j represents a counter value, and m represents the number of pieces of character candidate information 210 included in the new combination graph G_new.

The combination graph integration unit 13 first initializes the counter value j (j=0) (Step S301). Thereafter, the combination graph integration unit 13 extracts one piece of character candidate information 210 sequentially from the left side of the new combination graph G_new (Step S302) and increments the counter value j (j=j+1) (Step S303).

Next, the combination graph integration unit 13 specifies two pieces of connection information 220 on the cumulative combination graph G_acc side corresponding to the right and left sides of the character candidate information 210 extracted in Step S302, that is, the j-th character candidate information 210 from the left side of the new combination graph G_new side (Step S304). Then, the combination graph integration unit 13 determines whether one piece of character candidate information 210 sandwiched between the two pieces of connection information 220 specified in Step S304 is present on the cumulative combination graph G_acc side (Step S305).

Here, when such character candidate information 210 is present on the cumulative combination graph G_acc side (Step S305: Yes), the combination graph integration unit 13 regards the character candidate information 210 as the character candidate information 210 on the cumulative combination graph G_acc side corresponding to the j-th character candidate information 210 from the left side of the new combination graph G_new side, and merges the j-th character candidate information 210 from the left side of the new combination graph G_new side into the character candidate information 210 on the cumulative combination graph G_acc side (Step S306). On the other hand, when there is no such character candidate information 210 on the cumulative combination graph G_acc side (Step S305: No), the combination graph integration unit 13 determines that the character candidate information 210 corresponding to the j-th character candidate information 210 from the left side of the new combination graph G_new side is not present in the cumulative combination graph G_acc, and adds the j-th character candidate information 210 from the left side of the new combination graph G_new side to the cumulative combination graph G_acc (Step S307).

Thereafter, the combination graph integration unit 13 determines whether the counter value j has reached m to determine whether the processing for the entire character candidate information 210 included in the new combination graph G_new has ended (Step S308). Then, when there is character candidate information 210 for which the processing has not been ended (Step S308: No), the process returns to Step S302, and the subsequent processing is repeated. When the processing for the entire character candidate information 210 has ended (Step S308: Yes), the series of processes is ended.

As described above in detail with reference to specific examples, the character recognition apparatus 10 according to the embodiment generates the combination graph G in which the pieces of character candidate information 210 each of which includes one or more candidate characters are connected by the character recognition process on the character string image IS, integrates the plurality of combination graphs G generated for one character string, and outputs the integrated combination graph G or the recognition character string generated based on the integrated combination graph G. Therefore, it is possible to output a recognition result that is tenacious against erroneous reading or erroneous character delimitation and to perform highly accurate character recognition as compared with a conventional method of selecting a recognition result with a high degree of reliability for a corresponding character from a plurality of character recognition results and obtaining a final recognition character string.

Hereinafter, modifications of the above-described embodiment will be described.

Modification 1

In the above-described embodiment, the association of the character candidate information 210 in the plurality of combination graphs G is performed based on the position information included in the character candidate information 210. However, when a plurality of combination graphs G is generated from different character string images IS, position information of character candidate information 210 corresponding to each other is not necessarily coincident. Although the error range is provided for the coincidence determination of position information in the above-described embodiment, it is also assumed that positions where the same character exists are greatly different from each other in a plurality of character string images IS including the same character string.

Thus, when integrating the plurality of combination graphs G generated from the plurality of character string images IS including the same character string, positioning (registration) of the plurality of character string images IS may be performed, and the association between pieces of the character candidate information 210 in the plurality of combination graphs G may be performed based on position information converted in accordance with a result of the positioning.

In this case, when receiving the combination graph G from the combination graph generation unit 12, the combination graph integration unit 13 also receives the character string image IS which has been used to generate the combination graph G. Then, when integrating the combination graph G, the positioning of the character string image IS is first performed, and each piece of position information of the character candidate information 210 included in the combination graph G to be integrated is converted in accordance with the result of the positioning. Then, the converted position information is used to perform the association between pieces of the character candidate information 210 by the same method as in the above-described embodiment. Incidentally, an existing technique can be directly applied for the image positioning (registration), and thus, the detailed description thereof will be omitted.

In the present modification, the association of the character candidate information 210 in the plurality of combination graphs G is performed based on the position information converted in accordance with the result of positioning of the character string image IS. Accordingly, it is possible to suitably perform the association of the character candidate information 210 and perform highly accurate character recognition even when the positions where the same character exists in the plurality of character string images IS are greatly different from each other.

Modification 2

The association of the character candidate information 210 in the plurality of combination graphs G can be performed using continuity between pieces of adjacent character candidate information 210 as a clue as well as the position information of the character candidate information 210. Hereinafter, a description will be given regarding an example of an association method of the character candidate information 210 using the continuity between pieces of adjacent character candidate information 210 as a clue.

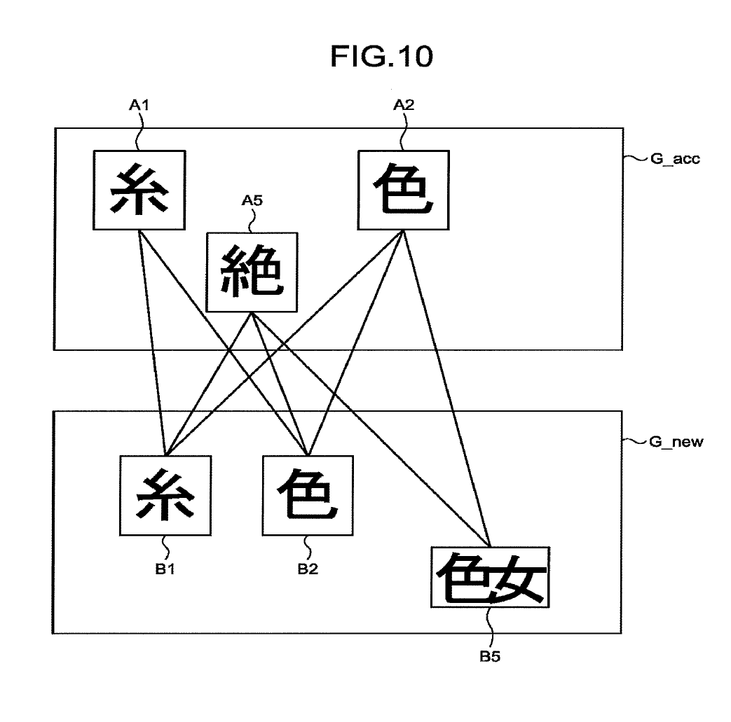

FIG. 10 is a view illustrating some pieces of character candidate information 210 extracted from the cumulative combination graph G_acc and the new combination graph G_new illustrated in FIG. 5. In FIG. 10, lines connecting the character candidate information 210 (A1, A2, and A5) on the cumulative combination graph G_acc side and the character candidate information 210 (B1, B2, and B5) on the new combination graph G_new side represent candidates of association of character candidate information 210, respectively. As illustrated in FIG. 10, one piece of character candidate information 210 has a plurality of association candidates.

In the present modification, scores are prepared for such association candidates, respectively. As an initial value of the score, a score is set based on a positional deviation amount obtained from a relative positional relationship of each character in a character string, closeness of a recognition result, and the like. For example, a coordinate value in the character string is expressed to be normalized such that the upper left is 0 and the lower right is 1, and the score is calculated based on the normalized coordinate value. Specifically, there is a method of calculating a square of an absolute value of a difference between a normalized coordinate value of the character candidate information 210 on the cumulative combination graph G_acc side and a normalized coordinate value of the character candidate information 210 on the new combination graph G_new side, and obtaining a sum of all the squares of absolute values. In addition, when there is the same character code between the character candidate information 210 on the cumulative combination graph G_acc side and the character candidate information 210 on the new combination graph G_new side, a sum of recognition scores corresponding thereto may be obtained, a character code with the best recognition score may be found, and the score of the association candidate herein may be determined based on the recognition score of the character code. In addition, the score of the association candidate herein may be determined by combining the above-described two scores.

Next, with respect to two pieces of adjacent character candidate information 210 in the new combination graph G_new, a pair of two pieces of adjacent character candidate information 210 on the cumulative combination graph G_acc side, which is an association candidate of these pieces of character candidate information 210, is found out. In general, a plurality of such pairs of character candidate information 210 is found.

Next, each score is updated based on scores of association candidates between two pieces of character candidate information 210 on the new combination graph G_new side and two pieces of character candidate information 210 on the cumulative combination graph G_acc side. For example, a predetermined constant is added to each score when a score of an association candidate between both the sides exceeds an average score, a predetermined constant is subtracted from each score when the score of the association candidate between both the sides is lower than the average score, and the addition or subtraction of the score is not performed in the other case. As this process is repeated, a score of the most likely association candidate increases, and a score of the least likely association candidate decreases. The above-described process is performed for a certain number of times or until a score variation falls below a threshold.

Next, association between the character candidate information 210 on the new combination graph G_new side and the character candidate information 210 on the cumulative combination graph G_acc side is determined in the descending order of scores of association candidates. In the process, the association including the character candidate information 210 whose association has already been determined is not adopted. In addition, when a score of an association candidate is lower than the threshold, this association between pieces of character candidate information 210 is not adopted. Accordingly, it is possible to finally obtain the association between pieces of valid character candidate information 210. Incidentally, the association herein is not to make one-to-one correspondence of the entire character candidate information 210 between the new combination graph G_new side and the cumulative combination graph G_acc side, but includes the character candidate information 210 without one-to-one correspondence, that is, with one-to-zero or zero-to-one correspondence.

The above association method is a method known as a relaxation method. The character recognition apparatus 10 according to the above-described embodiment may be configured such that the association of the character candidate information 210 is performed by the above relaxation method in the integration process of the combination graph G in the combination graph integration unit 13. As a result, even when it is difficult to associate the character candidate information 210 based on the position information, it is possible to associate the character candidate information 210 appropriately and perform highly accurate character recognition.

Modification 3

Next, another example of the method of integrating the plurality of combination graphs G will be described. In the integration method of this example, each of the cumulative combination graph G_acc having a plurality of connection paths and the new combination graph G_new having a plurality of connection paths is separated into a single connection path. Then, a corresponding relationship of the connection path between the cumulative combination graph G_acc side and the new combination graph G_new side is specified, and pieces of character candidate information 210 included in the corresponding connection paths are merged. In addition, with respect to a connection path on the new combination graph G_new side that does not correspond to any of connection paths on the cumulative combination graph G_acc side, the character candidate information 210 included in this connection path is added to any of the connection paths on the cumulative combination graph G_acc side. Thereafter, all the connection paths on the cumulative combination graph G_acc side are combined to obtain a new cumulative combination graph G_acc.

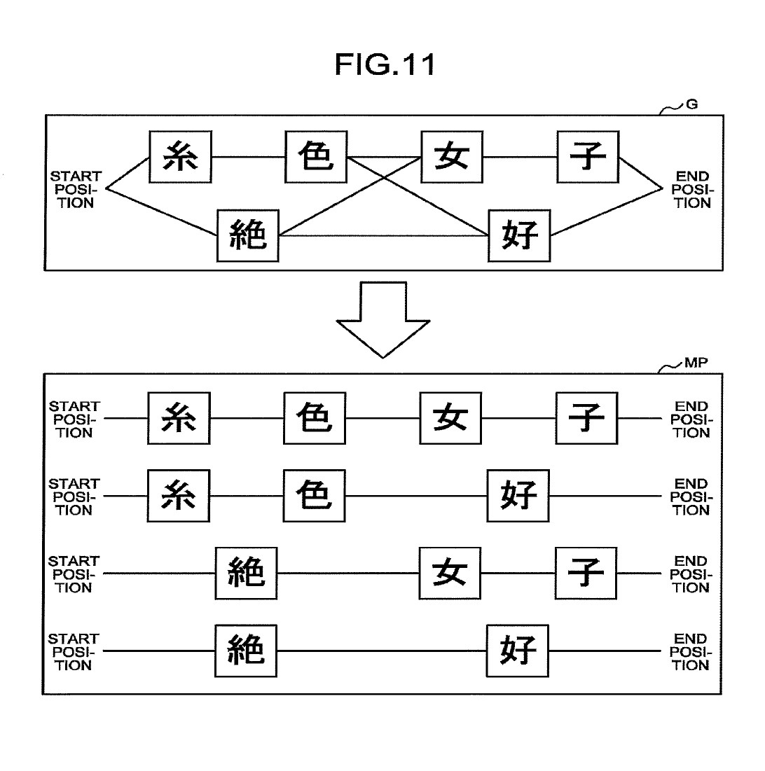

FIG. 11 is a view illustrating a state where the combination graph G is separated into a single connection path. A set of single connection paths separated from the combination graph G will be referred to as multiple single-line path MP hereinafter. The multiple single-line path MP can be constructed by tracing the character candidate information 210 included in the combination graph G in order from the left and generating individual connection paths for each branch. At this time, data on any character candidate information 210 in the original combination graph G from which each piece of character candidate information 210 included in each generated connection path is derived is attached. In addition, for example, scores of connection paths may be calculated based on the recognition score or the like included in the character candidate information 210, and a limit may be provided on the number of connection paths included in the multiple single-line path MP such that only the top n connection paths remain, or only the connection paths having scores equal to or larger than a threshold remain.

In this example, the above separation of the connection path is performed for both the cumulative combination graph G_acc and the new combination graph G_new. Then, a corresponding relationship between a connection path on the cumulative combination graph G_acc side and a connection path on the new combination graph G_new side is specified using a matching score between pieces of character candidate information 210 included in the respective connection paths. Specifically, the corresponding relationship between the connection path on the cumulative combination graph G_acc side and the connection path on the new combination graph G_new side is specified by the following method.

Consecutive pieces of character candidate information 210 in the connection path on the cumulative combination graph G_acc side are defined as A0, A1, . . . , and An−1, and consecutive pieces of character candidate information 210 in the connection path on the new combination graph G_new side are defined as B0, B1, . . . , and Bm−1. A matching score between pieces of character candidate information 210 is calculated using a recognition score included in each piece of character candidate information 210, a position or a size of a character area, or the like. Such a matching score between pieces of character candidate information 210 is calculated for a predetermined number of combinations of character candidate information 210 from a head of the connection path, and the pieces of character candidate information 210 for which the best matching score has been obtained is specified. Then, a matching score between pieces of character candidate information 210 is similarly calculated for each of the predetermined number of combinations of character candidate information 210 from character candidate information 210 next to the character candidate information 210 for which the best matching score has been obtained in each of the connection path on the cumulative combination graph G_acc side and the connection path on the new combination graph G_new side. Then, the obtained best matching score is added to the matching score obtained until then.

Here, it is assumed that a matching score between Ak−1 and Bh−1 is the best. In this case, in the next step, a matching score is calculated for each combination of (2d−1) pairs of pieces of character candidate information 210 in total between d pieces of character candidate information 210 of Ak to (Ak+d−1) and d pieces of character candidate information 210 of Bh to (Bh+d−1). Then, the best matching score among the obtained matching scores is added to the matching score obtained by the processing up to Ak−1 and Bh−1. At this time, when pieces of character candidate information 210 for which the best matching score is obtained are not consecutive in the connection path on the cumulative combination graph G_acc side and the connection path on the new combination graph G_new side, the matching score is adjusted to be lowered in accordance with the number of pieces of character candidate information 210 therebetween. This process is performed until a combination of the last character candidate information 210 of the connection path on the cumulative combination graph G_acc side and the last character candidate information 210 of the connection path on the new combination graph G_new side, thereby obtaining a final matching score between the connection path on the cumulative combination graph G_acc side and the connection path on the new combination graph G_new side. A score calculation method used here is one kind based on a so-called Levenshtein distance, and a matching scheme is called dynamic programming (DP). However, the score calculation method and the matching scheme are not limited to the above examples.

In the above description, the processing is progressed regarding the combination of character candidate information 210 for which the best matching score has been obtained, as the combination of character candidate information 210 that has been matched, among the combinations of (2d−1) pairs of pieces of character candidate information 210. However, the top T combinations in the descending order of matching score may be left as candidates, and the same processing as described above may be performed for each of the combinations. A method of leaving the top T combinations as above is called beam search.

In this example, a matching score between connection paths is calculated by the above processing for combinations of all connection paths on the cumulative combination graph G_acc side and all connection paths on the new combination graph G_new side. Then, a set of a connection path on the cumulative combination graph G_acc side and a connection path on the new combination graph G_new side for which a matching score is the maximum is specified. When the matching score exceeds a predetermined threshold, it is regarded that these connection paths correspond to each other, and pieces of the character candidate information 210 included in these connection paths are merged by the same method as in the above-described embodiment. On the other hand, the character candidate information 210 included in a connection path on the new combination graph G_new side is added to a connection path on the cumulative combination graph G_acc side for a set of the connection paths for which a matching score is equal to or less than the threshold using the same method as in the above-described embodiment. Finally, all the connection paths on the cumulative combination graph G_acc side are combined to obtain a new cumulative combination graph G_acc.

In the character recognition apparatus 10 according to the above-described embodiment, the integration process of the combination graph G in the combination graph integration unit 13 may be performed by the method of this example described above. As a result, even when the number of connection paths of the cumulative combination graph G_acc and the new combination graph G_new is large, it is possible to appropriately perform the integration process of the combination graph G and perform highly accurate character recognition.

### Supplemental Description

For example, when using a computer as a hardware configuration of the character recognition apparatus 10, each function of the character recognition apparatus 10 according to the above-described embodiment can be implemented by executing a predetermined program using this computer. The program to be executed by the computer used as the character recognition apparatus 10 is provided, for example, as a computer program product by being recorded in a computer-readable recording medium, such as a compact disk read only memory (CD-ROM), a flexible disk (FD), a compact disk recordable (CD-R), and a digital versatile disc (DVD), in a file of an installable format or an executable format.

In addition, the program to be executed by the computer used as the character recognition apparatus 10 may be configured to be stored on another computer connected to a network such as the Internet and to be provided by being downloaded via the network. In addition, the program to be executed by the computer used as the character recognition apparatus 10 may be configured to be provided or distributed via a network such as the Internet. In addition, the program to be executed by the computer used as the character recognition apparatus 10 may be configured to be provided in the state of being incorporated, in advance, in the ROM 102 or the like inside the computer.

The program to be executed by the computer used as the character recognition apparatus 10 is configured as a module including the above-described functional elements (the character string image acquisition unit 11, the combination graph generation unit 12, the combination graph integration unit 13, the recognition character string generation unit 14, and the output unit 15) of the character recognition apparatus 10. As actual hardware, for example, the CPU 101 reads the program from the recording medium and executes the read program such that the above-described respective constituent elements are loaded on a main storage unit, such as the RAM 103, and the above-described respective constituent elements are generated on the main storage unit. Incidentally, some or all of the functional elements of the character recognition apparatus 10 can be also implemented by using dedicated hardware such as an application specific integrated circuit (ASIC) or a field-programmable gate array (FPGA).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A character recognition apparatus comprising:
a character string image acquisition unit that acquires a character string image;
a combination graph generation unit that performs a character recognition process on the character string image and generates a combination graph in which a plurality of pieces of character candidate information each of which includes one or more candidate characters is connected according to an arrangement order of the respective character areas in the character string image, the character candidate information representing a recognition result for each character area regarded as one character;
a combination graph integration unit that integrates a plurality of the combination graphs generated from a plurality of the character string images including an identical character string or integrates a plurality of the combination graphs generated by performing a plurality of different character recognition processes on the single character string image; and
an output unit that outputs the integrated combination graph or a recognition character string obtained based on the integrated combination graph.

2. The character recognition apparatus according to claim 1, wherein
the combination graph integration unit specifies a corresponding relationship between the character candidate information included in a first combination graph and the character candidate information included in a second combination graph, merges pieces of the character candidate information corresponding to each other between the first combination graph and the second combination graph into one piece of the character candidate information, and integrates the first combination graph and the second combination graph by adding the character candidate information included in the second combination graph, the character candidate information not corresponding to any of the character candidate information included in the first combination graph, to the first combination graph.

3. The character recognition apparatus according to claim 2, wherein
the character candidate information includes position information indicating a position of a character area in the character string image, and
the combination graph integration unit specifies a corresponding relationship between the character candidate information included in the first combination graph and the character candidate information included in the second combination graph based on the position information.

4. The character recognition apparatus according to claim 3, wherein the combination graph integration unit performs positioning of the plurality of character string images when integrating the plurality of combination graphs generated from the plurality of character string images including the identical character string, and specifies a corresponding relationship between the character candidate information included in the first combination graph and the character candidate information included in the second combination graph based on the position information converted in accordance with a result of the positioning.

5. The character recognition apparatus according to claim 2, wherein the combination graph integration unit specifies a corresponding relationship between the character candidate information included in the first combination graph and the character candidate information included in the second combination graph by a relaxation method.

6. The character recognition apparatus according to claim 2, wherein
the combination graph includes a plurality of connection paths indicating connection of pieces of the character candidate information in each of patterns according to the plurality of patterns having different character area delimiters in the character string image,
the combination graph integration unit separates each of the first combination graph and the second combination graph into the single connection path and then specifies a corresponding relationship between the connection path of the first combination graph and the connection path of the second combination graph, merges pieces of the character candidate information included in the connection paths corresponding to each other between the first combination graph and the second combination graph into one piece of the character candidate information, and integrates the first combination graph and the second combination graph by adding the character candidate information included the connection path of the second combination graph, the connection path that does not correspond to any of the connection paths of the first combination graph, to any of the connection paths of the first combination graph and then combining the plurality of connection paths of the first combination graph.

7. The character recognition apparatus according to claim 2, wherein
the combination graph includes connection information indicating a connection relationship between adjacent pieces of the character candidate information, and
the combination graph integration unit adds the character candidate information included in the second combination graph to the first combination graph by adding a connection relationship with the character candidate information included in the second combination graph to the connection information included in the first combination graph.

8. A character recognition method comprising:
acquiring a character string image;
performing a character recognition process on the character string image and generating a combination graph in which a plurality of pieces of character candidate information each of which includes one or more candidate characters is connected according to an arrangement order of the respective character areas in the character string image, the character candidate information representing a recognition result for each character area regarded as one character;
integrating a plurality of the combination graphs generated from a plurality of the character string images including an identical character string or integrating a plurality of the combination graphs generated by performing a plurality of different character recognition processes on the single character string image; and
outputting the integrated combination graph or a recognition character string obtained based on the integrated combination graph.

9. A computer program product having a non-transitory computer-readable medium containing a program executed by a computer, the program causing the computer to execute:
acquiring a character string image;
performing a character recognition process on the character string image and generating a combination graph in which a plurality of pieces of character candidate information each of which includes one or more candidate characters is connected according to an arrangement order of the respective character areas in the character string image, the character candidate information representing a recognition result for each character area regarded as one character;
integrating a plurality of the combination graphs generated from a plurality of the character string images including an identical character string or integrating a plurality of the combination graphs generated by performing a plurality of different character recognition processes on the single character string image; and
outputting the integrated combination graph or a recognition character string obtained based on the integrated combination graph.
